(19) United States
(12) Patent Application Publication
(10) Pub. No.: US 2025/0337570 A1
(43) Pub. Date: Oct. 30, 2025

(54) Hardware-Generated Key Encryption

(71) Applicant: Google LLC, Mountain View, CA (US)

(72) Inventors: Rangapriya Parthasarathy, San Jose, CA (US); Vinoth Kumar Deivasigamani, San Diego, CA (US)

(73) Assignee: Google LLC, Mountain View, CA (US)

(21) Appl. No.: 19/193,585

(22) Filed: Apr. 29, 2025

Related U.S. Application Data
(63) Continuation of application No. PCT/US2024/027062, filed on Apr. 30, 2024.

(51) Int. Cl. H04L 9/08

(52) U.S. Cl. CPC H04L 9/0877; H04L 9/0897

(57) ABSTRACT

Hardware-generated encryption keys are provided to enable per-file encryption of files to be stored in flash storage in a mobile device. Hardware-generated encryption keys are also used to decrypt encrypted files stored in the flash storage. A hardware key manager is configured to provide an unlimited number of child keys generated from one or more base keys. A nonce is applied to a base key to generate the child key. The hardware key manager communicates the child key to a host controller interface via a first bus. Software on the mobile device does not have access to the value of the child keys. A flash storage driver communicates commands to the host controller interface via a second bus. The host controller interface includes a cryptographic engine that utilizes the child keys to encrypt data to be written to the flash storage or decrypt data read from the flash storage.

### CROSS-REFERENCE TO RELATED APPLICATION

This application is a continuation of and claims priority to International Patent Application No. PCT/US2024/027062, filed 30 Apr. 2024, the disclosure of which is incorporated by reference herein in its entirety.

### BACKGROUND

It is estimated that almost 80% of the world's population owns a mobile phone, which is one type of mobile device. Mobile devices typically include a system-on-a-chip (SoC), which is the brain of the mobile device. The SoC includes various components, such as central processors, memory, graphic processors, audio processors, high-speed input and output line interfaces, and encryption engines. Mobile devices can include flash storage, also referred to herein as a flash storage device, which is positioned external to the SoC. Flash storage is used to store, on the mobile device, user data such as pictures and emails. It is standard practice to encrypt data stored on a mobile device for security purposes. As the performance of memory devices has continually increased, it has been important to increase the speed of the cryptographic process (e.g., encryption and decryption) of data on the mobile device to ensure efficient performance. Inline encryption on the SoC enables efficient encryption of data as the data is written to the flash storage and, likewise, efficient decryption of data on the SoC as it is read from the flash storage to the SoC. Implementing inline cryptographic operations in an efficient manner, however, can be challenging.

The SoC of a mobile device typically includes a host controller interface located within a flash storage wrapper. The host controller interface communicates between the SoC and the flash storage. The host controller interface includes a cryptographic engine used to encrypt data to be written into the flash storage as well as to decrypt data read from the flash storage by the SoC. The manufacturers of mobile devices often use an off-the-shelf third-party flash storage controller as the host controller interface in the flash storage wrapper. Third-party providers often do not offer any customizations for this controller.

### SUMMARY

This document describes using hardware-generated keys to provide per-file encryption. The document details how the disclosed hardware key manager is configured to provide an infinite, or unlimited, number of keys generated from one or more base keys. The base keys are located on the hardware key manager, which is located on the SoC of the mobile device. To provide per-file encryption, this document describes implementations that enable the hardware generation of an unlimited number of encryption keys. This enables inline encryption using different keys to perform per-file encryption. The hardware key manager may generate an unlimited number of child keys. Each child key is generated as the result of applying a nonce, also referred to herein as a tweak, to one of the base keys located on the hardware key manager. Even if the hardware key manager includes only a single base key, an unlimited number of child keys may still be generated by the hardware key manager as the nonce may be varied in an infinite number of ways. The hardware-generated child key may then be used by the host controller interface within the flash storage wrapper to encrypt or decrypt on a per-file basis.

This document details how an off-the-shelf third-party flash storage controller may be used as a host controller interface to provide file-based encryption using hardware-generated keys. A bus, also referred to herein as a communication line, is added to the off-the-shelf third-party flash storage controller to enable communication from the hardware key manager to the off-the-shelf third-party flash storage controller. The term bus includes a communication line, an input line, an output line, a conductor, an electrical bus, an energy bus, or the like. The hardware key manager generates the hardware keys used by the off-the-shelf third-party flash storage controller to encrypt and/or decrypt data. A flash memory driver sends a request to use a key with a cryptographic engine on the off-the-shelf third-party flash storage controller. However, both the flash memory driver and the off-the-shelf third-party flash storage controller do not have access to the value of the encryption keys generated by the hardware key manager.

This document details how the hardware key manager is configured to generate an infinite, or unlimited, number of children keys from a single base key or from a set of base keys. The hardware key manager uses a tweak, or a nonce, that is applied to a base key, also referred to as a parent key, to generate a child key. The document details that the generated child key is stored in a key table in the host controller interface. The cryptographic engine in the host controller interface accesses the child key from the key table to use a child key, as generated by the hardware key manager, to encrypt or decrypt data on the mobile device.

The flash storage wrapper includes two buses, also referred to herein as communication lines, to communicate with the host controller interface, which may be an off-the-shelf third-party flash storage controller located with the flash storage wrapper. The document details that a first bus of the flash storage wrapper is used to pass the hardware-generated key from a hardware key manager to the host controller interface. In some implementations, the hardware key manager is enabled to use the first bus to communicate the child key to the host controller interface of the flash storage wrapper, while other components (e.g., software) can be excluded from using the first bus. If the first bus is only accessible by the hardware key manager, software on the mobile device is prevented from having access to the value of the hardware-generated key. A second bus of the flash storage wrapper is used for the communication of software memory commands from the flash storage driver to the host controller interface. The software memory commands are used to instruct the host controller interface what data is to be stored to or read from flash storage as well as what encryption key for the cryptographic engine to use during the cryptographic processing. The software memory commands are sent to the host controller interface from the flash storage driver based on commands from high-level software, such as the operating system of the mobile device.

In example implementations a method includes receiving, at a flash storage wrapper, via a first bus, and from hardware, a first child key, the first child key generated from a base key by a hardware key manager within the hardware; receiving at the flash storage wrapper, via a second bus, and from a flash storage driver, a memory command; and encrypting, at the flash storage wrapper, a file using the first child key and in accordance with the memory command and directing a write of the encrypted file to a location of a flash storage device, the location based on the memory command received from the flash storage driver; or reading, at the flash storage wrapper, a file on the flash storage device, the location of the file based on the memory command received from the flash storage driver and decrypting, at the flash storage wrapper, the file using the first child key and in accordance with the memory command.

In example implementations, an apparatus includes a first bus configured to receive communications from hardware, a second bus configured to receive communications from software, and an arbiter connected to the first bus and the second bus. The arbiter includes an output line. The apparatus includes a host controller interface including a communication line connected to the output line of the arbiter. The host controller interface includes a first cryptographic engine and a key table. The key table includes a hardware-generated key, and the first cryptographic engine is configured to use the hardware-generated key to encrypt or decrypt a file.

In example implementations, a method includes generating, in a hardware key manager, a child key from a base key. The method includes transmitting, from the hardware key manager, the child key to a flash storage wrapper on a first bus. The method includes receiving, from a flash storage driver, a memory command at the flash storage wrapper on a second bus. The method includes using, at the flash storage wrapper, the child key to encrypt a file or decrypt a file. The method includes writing the encrypted file to or reading the decrypted file from a location on a flash storage device based on the memory command.

In example implementations, a system includes a flash storage device and a flash storage wrapper in communication with the flash storage device. The flash storage wrapper includes a first key table including multiple keys and multiple key slots. Each key of the multiple keys corresponds to a slot of the multiple key slots. The system includes a hardware key manager in communication with the flash storage wrapper via a first bus. The system includes a flash storage driver in communication with the flash storage wrapper via a second bus and with the hardware key manager via a third bus.

### BRIEF DESCRIPTION OF DRAWINGS

Apparatuses of and techniques for providing hardware-generated key encryption are described with reference to the following drawings. The same numbers are used throughout the drawings to reference like features and components.

FIG. 1 illustrates an example apparatus with an SoC including a hardware key manager and flash storage wrapper that can implement per-file storage encryption instructions.

FIG. 2 illustrates an example apparatus including a host controller interface, which may be an off-the-shelf third-party flash storage controller, that can implement per-file storage encryption instructions with a hardware-generated key.

FIG. 3 illustrates a schematic of an example hardware key manager receiving a nonce and generating a child key in response to the received nonce.

FIG. 4 illustrates an example system in which per-file storage encryption with a hardware-generated key can be implemented with an input/output (I/O) command sent to a flash storage driver from high-level software.

FIG. 4-1 illustrates the example system of FIG. 4 with key information sent to a hardware key manager from the flash storage driver, with a child key sent on a first bus from the hardware key manager to the flash storage wrapper, and with I/O information sent on a second bus to a flash storage wrapper from the flash storage driver.

FIG. 4-2 illustrates the example system of FIG. 4-1 with a read or write command sent to the flash storage device from the flash storage wrapper.

FIG. 5 is a flow chart illustrating an example process for using a hardware key for storage encryption.

FIG. 6 is a flow chart illustrating an example process for using a hardware key for storage encryption.

FIG. 7 is a flow chart illustrating an example process for generating a child key from a base key.

### DETAILED DESCRIPTION

### Overview

Mobile devices make important contributions to modern society, such as those related to communication, safety, manufacturing, and content creation. Mobile devices include an SoC, which is the brain of the device, and flash storage that is external to the SoC. Flash storage is used to store user data on the mobile device. The SoC provides inline cryptographic processes as data is written into and read from the flash storage of the mobile device. Various aspects of mobile devices follow standards that are approved by the Joint Electron Device Engineering Council (JEDEC) Solid State Technology Association, which is an independent semiconductor trade organization and standardization body. JEDEC has an approved standard regarding inline encryption and decryption that governs the cryptography processes used on mobile devices. The JEDEC inline encryption standard (JEDEC Universal Flash Storage Host Controller Interface “UFSHIC”) has enabled third-party companies to manufacture host controller interfaces that comply with the standard such that the host controller interface can be used within a mobile device of various manufacturers.

In the past, full disk encryption was used to encrypt data on flash storage. Full disk encryption uses a single key to encrypt all the stored data. To improve security, file-based encryption may be used instead of full disk encryption. File-based encryption enables different files that are stored in the flash storage to be encrypted with different keys. For example, one encryption key may be used to encrypt personal data while a different encryption key may be used to encrypt work data. As another example, one encryption key may be used to encrypt data read when the mobile device is unlocked, and a different encryption key may be used to encrypt text messages received when the mobile device is locked. Per-file encryption of flash storage provides better security in the event a malevolent action (e.g., a “hacker”) determines the value of an encryption key. If per-file encryption was used for data on a flash storage device, the hacker only gains access to data encrypted with the compromised encryption key and will not have access to any other data encrypted with a different encryption key.

The manufacturer of an SoC for a mobile device often uses an off-the-shelf third-party flash storage controller as the host controller interface in the flash storage wrapper rather than creating its own host controller interface. Off-the-shelf means the flash storage controller is not designed or made to order but is purchased from a third party from existing stock or supplies. This is economically more efficient because the third-party has already created circuitry that adheres to the applicable JEDEC standard and can interoperate with industry-standard flash storage devices. The off-the-shelf third-party flash storage controller typically performs per-file encryption. One potential issue regarding per-file encryption is that the host controller interface on the mobile device may need access to a large number of different keys to efficiently perform per-file encryption or decryption. This document describes hardware and techniques that enable a large number of different keys to be used to perform per-file encryption or decryption.

The host controller interface is located within a flash storage wrapper located on the SoC of the mobile device. The host controller interface includes a key table that has a finite number of keys within the key table. The keys from the key table are used by a cryptographic engine within the host controller interface to cryptographically process files, or data, within the mobile device. Typically, the key table includes 16 key slots or 32 key slots but may include more or less in some applications. This relatively low finite number of available keys in the key table may make it impractical for the cryptographic engine of the host controller interface to efficiently conduct per-file encryption. This is because the host controller interface, specifically the cryptographic engine, may not have access to enough keys at one time to efficiently perform the per-file encryption for a large set of files or file categories. If there are not enough keys available for efficient per-file encryption, the cryptographic engine of the host controller interface may need to wait for software on the mobile device to continually reprogram the key table in order to make an adequate number of keys available to the cryptographic engine. The reprogramming of the key table may result in unacceptable lag, or delay, during the cryptographic process for a large set of files. This document describes hardware and techniques that enable a large number of different keys to be used to reduce or eliminate unacceptable lag, or delay, for the reprogramming of the key table.

The SoC is integral to the security of the mobile device. In other words, the components and data residing within the SoC are generally considered to be secure. As the complexity of the mobile device increases, the mobile device includes more and more software. The greater the amount of software on a mobile device, the greater the number of possible vulnerabilities through which the mobile device may be nefariously accessed. Any software that resides outside of the SoC boundary is typically considered to be a potential access point that may be susceptible to malevolent actions.

To provide security, user data on mobile devices, which is stored in the flash storage, can be encrypted. Although the host controller interface, which often is a third-party off-the-shelf flash storage controller, is located on the SoC, software on the mobile device presently programs the keys in the key table of the host controller interface. As such, in present mobile devices software on the mobile device has access to the values of the encryption keys used to encrypt the user data on the flash storage device in the mobile device. As discussed herein, software that has access to the encryption key values may be susceptible to a malevolent action. If the encryption key values are obtained, the malevolent action can access and decrypt some, if not all, of the user's data on the mobile device depending on the number of keys obtained by the malevolent action. This document describes hardware and techniques for the creation of hardware-generated keys for the encryption of files, or data, that are not as vulnerable as software generated encryption keys.

This document details how a hardware key manager is configured to provide an unlimited, or effectively infinite, number of keys. To provide per-file encryption, this document describes implementations that enable the use of an unlimited number of child encryption keys generated by the hardware key manager. The hardware-generated child keys enable efficient inline encryption with different keys on a per-file basis.

This document describes that an unlimited number of child keys may be generated by the hardware key manager from one or more base keys found in a base key table within the hardware key manager. Each child key, generated by the hardware key manager, is the result of applying a nonce, also referred to herein as a tweak, to a base key located in a base key table found in the hardware key manager. The nonce applied to a base key may be varied in an infinite, or unlimited, number of ways, resulting in the potential for the hardware key manager to be able to generate an unlimited number of unique child keys. In this manner, the hardware key manager is configured to generate an unlimited number of child keys even from a single base key by the application of different nonces to the single base key. After the child key is generated, the hardware key manager communicates the child key to the host controller interface within the flash storage wrapper to be stored in a key table within the host controller interface. The cryptographic engine may then access the child key from the key table to encrypt or decrypt on a per-file basis as instructed by the flash storage driver.

This document details that software on the mobile device has access to use the hardware-generated encryption keys (also referred herein as hardware-generated keys and child keys) in the flash storage wrapper during the cryptographic process, but the software does not have access to the value of the hardware-generated keys. The disclosed hardware key manager generates the hardware-generated keys and can prevent access by software to the values of the hardware-generated keys. In some implementations, the hardware key manager may be the only component on the mobile device with access to the values of the hardware-generated keys. The hardware key manager is located within the boundary of the SoC and, as such, is much less vulnerable to potential malevolent actions than the software or the flash storage device of the mobile device, which are both located outside of the security boundary of the SoC. The use of hardware-generated keys with values known only to the hardware key manager located on the SoC, or with values otherwise having a limited accessibility, decreases the likelihood that a malevolent action can access and decrypt the user data stored on the flash storage device.

Off-the-shelf third-party flash storage controllers are not configured to receive a hardware-generated key from a hardware key manager. The document describes a host controller interface, positioned within the flash storage wrapper. The storage wrapper includes a first bus connected to the hardware key manager and a second bus for receiving software memory commands from a flash storage driver. The first bus from the hardware key manager may be used to augment third-party off-the-shelf flash storage controller to enable the host controller interface to be able to receive a child key from the hardware key manager. In addition, the firmware of the flash storage wrapper can be updated to include the functionality of receiving a hardware-generated encryption key via the first bus from the hardware key manager.

This document details that the only traffic on the first bus between the hardware key manager and the flash storage wrapper may be the passing of the hardware-generated child key as described in the document. The second bus to the flash storage wrapper enables memory communications between the flash storage driver and the host controller interface. The host controller interface will receive I/O information and commands from the flash storage driver via the second bus to the flash storage wrapper.

Third-party off-the-shelf flash storage host controller interfaces are configured to receive communications via a single bus or communication line. Present interfaces to the host controller interface are not configured to receive communications from two different buses or communication lines at the same time. To address this limitation, this document describes an arbiter in the flash storage wrapper. The arbiter is connected to the first bus from the key hardware manager and the second bus connected to the flash storage driver. The arbiter has an output line connected to a configuration interface of the host controller interface in the flash storage wrapper. The arbiter arbitrates the communications, or signals, between the first and second buses with the configuration interface of the host controller interface so that communications are received one at a time at the host controller interface. In other words, the configuration interface of the host controller interface is not configured to receive instructions from the first bus and the second bus at the same time.

To prevent a software-generated key from being communicated to the host controller interface via the second bus, this document describes a controller within the flash storage wrapper with the controller being positioned between the hardware key manager and the arbiter. The controller is connected to the first bus from the hardware key manager and the second bus from the flash storage driver. The controller performs access control and key policy checks. The controller is configured to allow the hardware-generated key, generated by the hardware key manager, to be communicated to the host controller interface and prevent a software-generated key from being communicated to the host controller interface.

As discussed herein, an SoC may require a large set of encryption keys when performing per-file encryption. This may require the continual reprogramming of a key table by the software of a mobile device that is also generating the encryption keys, which may lead to undesired lag during the encryption process. Further, software-generated encryption keys may potentially be vulnerable to malevolent actions. Hardware-generated encryptions keys may be used to overcome these issues. However, off-the-shelf third-party flash storage controllers are not configured to receive a hardware-generated key from a hardware key manager and are configured to receive communications from a single communication line. Potentially, a software-generated key could still be communicated to the host controller interface within the flash storage wrapper via the second bus connected to the flash storage driver.

To overcome these issues, this document details a hardware key manager that is configured to generate a potentially unlimited number of keys that may be used by the SoC for per file encryption. The hardware key manager creates hardware-generated encryption keys that are less vulnerable to malevolent actions than software-generated encryption keys. This document details a flash storage wrapper that includes two buses, also referred to herein as communication lines, to enable the hardware-generated encryption key to be pass from the hardware key manager to a host controller interface, which may be an off-the-shelf third-party controller, within the flash storage wrapper. This document describes an arbiter that arbitrates the communications, or signals, between the first and second buses with the configuration interface of the host controller interface so that communications are received one at a time at the host controller interface. This document details a controller that is configured to allow the hardware-generated key, generated by the hardware key manager, to be communicated to the host controller interface and prevent a software-generated key from being communicated to the host controller interface. These and other implementations are described herein.

### Example Environments and Electronic Devices

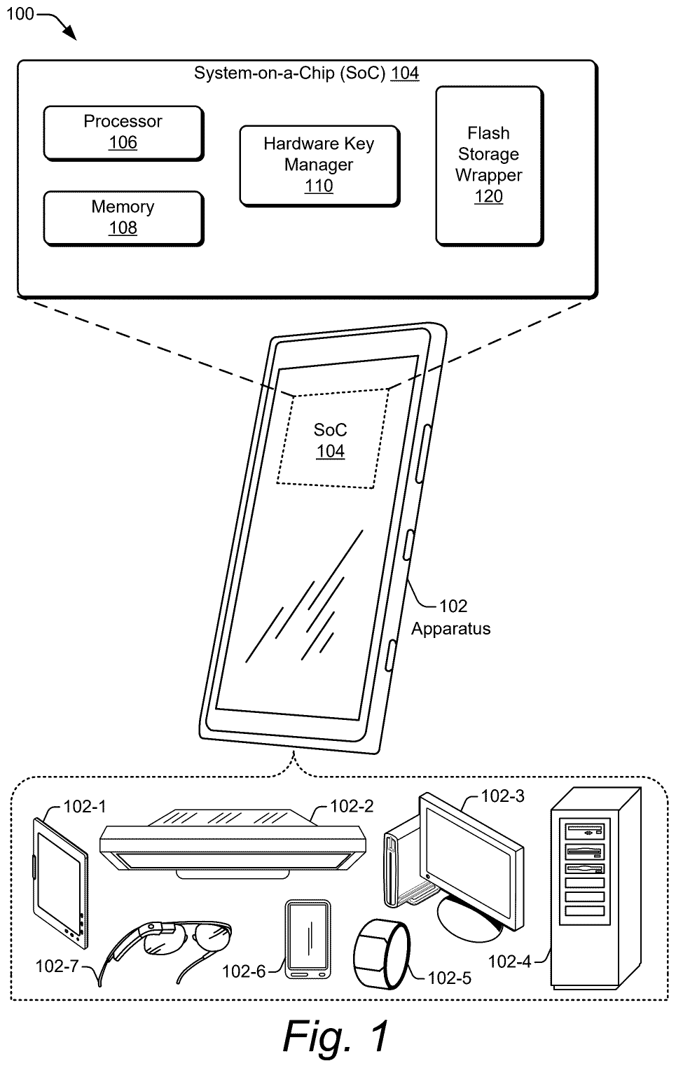

FIG. 1 illustrates an example environment 100 including an apparatus 102. The apparatus 102 may include a mobile phone, a smart phone, smart watch, tablet, laptop, mobile computer, handheld computer, digital assistant, or the like. The apparatus 102 includes an SoC 104, which includes at least a processor 106, memory 108, a hardware key manager 110, and a flash storage wrapper 120. The apparatus 102, using the components of the SoC 104, can implement instructions for hardware-generated key encryption of files, or data, in the memory 108 located on the SoC 104, to be stored in a flash storage device within the apparatus 102. The flash storage device is located within the apparatus 102, but the flash storage device is located external to the SoC 104. In implementations, the instructions for using a hardware-generated encryption key to perform per-file encryption as described herein.

The hardware key manager 110, located on the SoC 104, is configured to generate an encryption key to be used by the flash storage wrapper 120 for cryptographic processing (e.g., encryption or decryption) of files, or data, within the apparatus 102. The hardware key manager 110 is configured to create a hardware-generated encryption key as discussed herein.

In this example, the apparatus 102 is depicted as a smartphone. The apparatus 102 may, however, be implemented as any suitable computing or other electronic device. Examples of the apparatus 102 include a mobile electronic device or mobile device, mobile communication device, modem, cellular or mobile phone, mobile station, gaming device, navigation device, media or entertainment device (e.g., a media streamer or gaming controller), laptop computer, desktop computer, tablet computer, smart appliance, vehicle-based electronic system, wearable computing device (e.g., clothing, watch, or reality-altering glasses), Internet of Things (IoTs) device, sensor, stock management device, electronic portion of a machine or piece of equipment (e.g., vehicle or robot), memory storage device (e.g., a solid-state drive (SSD)), server computer or portion thereof (e.g., a server blade or rack or another part of a datacenter), and the like. Illustrated examples of the apparatus 102 include a tablet device 102-1, a smart television 102-2, a desktop computer 102-3, a server computer 102-4, a smartwatch 102-5, a smartphone (or document reader) 102-6, and intelligent glasses 102-7.

In example implementations, the apparatus 102 includes the SoC 104 that is the brains of the apparatus 102. The SoC 104 is typically a complex chip that includes a number of different components, such as processors, memory, encryption engines, and high-speed input and output line. The SoC 104 typically comprises a single integrated circuit. The integrated circuit can be part of, or realized as, a chip, a package, a module, an assembly, or at least one printed circuit board (PCB) (not shown). Examples of a PCB include a flexible PCB, a rigid PCB, a single- or multi-layered PCB, a surface-mounted or through-hole PCB, combinations thereof, and so forth. One or more integrated circuit (IC) chips can be mounted on a PCB. Each IC chip can be realized as a general-purpose processor, a microcontroller, an application-specific IC (ASIC), and so forth. Other examples of IC chips include a security-oriented IC chip, a memory chip, a communications IC chip (e.g., a modem or radio-frequency IC), a graphics processor, an artificial intelligence (AI) accelerator, sensor chips, combinations thereof, and so forth. Sensor chips may include, for example, an accelerometer, a camera or other light sensor, a satellite positioning system (e.g., a Global Positioning System (GPS)) chip, and the like. An integrated circuit chip can be packaged alone or together with other IC chips. Although some of this disclosure refers to utilizing techniques in conjunction with an SoC, the invention is not so limited. For example, a hardware key manager 110 and a flash storage wrapper 120 as described herein can be included in other circuits, such as any integrated circuit or chip that accesses a flash storage device that includes encrypted data.

### Example Apparatuses, Systems, and Operational Schemes

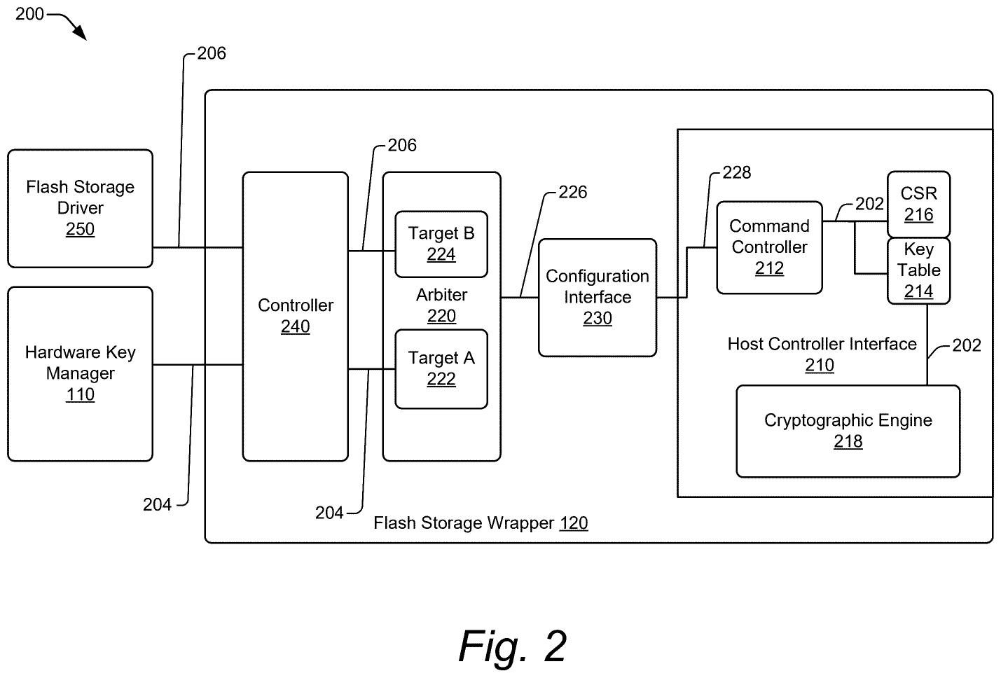

FIG. 2 illustrates, at 200 generally, an example flash storage wrapper 120 that is located on an SoC 104 of a mobile device 102. Components within the flash storage wrapper 120 may be used to encrypt data as it goes out from the SoC 104 to a flash storage device 420 of the mobile device 102. Likewise, components within the flash storage wrapper 120 may be used to decrypt data as it is read from the flash storage device to the SoC 104. Since the flash storage wrapper 120 is located on the SoC 104, cryptographic processing (e.g., encryption or decryption) of files, or data, may be performed inline as the files, or data, move from the SoC 104 to the flash storage device or move from the flash storage device to the SoC 104. The flash storage wrapper 120 includes multiple communication lines, generally referred to as 202, that enable communications between the various components within the flash storage wrapper 120. In some implementations, the flash storage wrapper 120 includes a first bus 204 configured to enable communications between a hardware key manager 110 and a host controller interface 210. The flash storage wrapper 120 includes a second bus 206 configured for the host controller interface 210 to receive I/O commands and/or I/O information as detailed herein.

The host controller interface 210 of the flash storage wrapper 120 communicates between the flash storage wrapper 120 and the flash storage device of the mobile device 102. The host controller interface 210 encrypts data being written into the flash storage device and decrypts data being read from the flash storage device as detailed herein. The host controller interface 210 may be an off-the-shelf third-party flash storage controller that the SoC manufacturer has licensed from the third party. In other words, the host controller interface 210 may be provided by an entity other than the manufacturer of the mobile device 102 as discussed herein. The host controller interface 210 in mobile devices 102 is often an off-the-shelf third-party flash storage controller since the inline cryptographic process is a standard set by JEDEC.

The host controller interface 210 includes a communication line 228, a command controller 212, a key table 214, a control status register (CSR) 216, and a first cryptographic engine 218. The key table 214 includes multiple encryption keys, each of which is also generally referred to herein as a key, located in key slots. An encryption key may be used by the first cryptographic engine 218 to encrypt files, or data, being written into the flash storage device or to decrypt encrypted files, or data, being read out of the flash storage device. In one implementation, the encryption keys located in the key table 214, of the host controller interface 210, are child keys 340 generated by the hardware key manager 110 as described herein. The key table 214 of the host controller interface 210 includes a finite, or set, number of key slots. Each key slot is configured to hold an encryption key.

The flash storage wrapper 120 includes a first bus, or first communication line, 204 and a second bus, or second communication line, 206. The first bus 204 is connected to the hardware key manager 110 and enables the hardware key manager 110 to communicate with the flash storage wrapper 120. The hardware key manager 110 transmits hardware-generated encryption keys (e.g., child keys) to the key table 214 located on the host controller interface 210. The child keys are hardware-generated encryption keys that are created by the hardware key manager 110 as detailed herein.

The second bus, or second communication line, 206 of the flash storage wrapper 120 connects the host controller interface 210 with a flash storage driver 250. A processor 106 of the apparatus 102 is configured to execute the flash storage driver 250 in communication with the second bus 206. The flash storage driver 250 is also in communication with the hardware key manager 110 as discussed herein. The flash storage driver 250 is configured to communicate memory commands to the host controller interface 210 via the second bus 206 and to communicate a nonce to the hardware key manager 110 via a third bus 414 as detailed below. Memory control commands and/or communications (e.g., I/O commands and/or I/O communications) are transmitted between the flash storage driver 250, of the mobile device 102, and the host controller interface 210, of the flash storage wrapper 120, via the second bus 206. In some implementations, the second bus 206 is an Advanced Microcontroller Bus Architecture (AMBA) bus, and the communications on the second bus 206 between the flash storage driver 250 and the host controller interface 210 use the Advanced extensible Interface (AXI) protocol.

In some implementations, the flash storage wrapper 120 includes an arbiter 220 that is connected to the first bus 204 and the second bus 206 of the flash storage wrapper 120. A configuration interface 230 is positioned between the arbiter 220 and the host controller interface 210. The arbiter 220 includes an output line 226, also referred to herein as a communication line, connected to the host controller interface 210 via the configuration interface 230 and a communication line 228 of the host controller interface 210. The arbiter 220 arbitrates communications, or signals, between a target A 222 connected to the first bus 204 of the flash storage wrapper 120 and a target B 224 connected to the second bus 206 of the flash storage wrapper 120. The arbiter 220 arbitrates the communications because the configuration interface 230, which is connected between the arbiter 220 and the host controller interface 210, is configured to receive communications one at a time from either the first bus 204 or the second bus 206. The arbiter 220 ensures programming, via the communication lines 204, 206, of the components 212, 214, 216, 218 within the host controller interface 210 happens one at a time through the configuration interface 230. In other words, the configuration interface 230 is not configured to receive instructions from both the first bus 204 and the second bus 206 at the same time. Thus, the arbiter 220 or a controller 240 (described below) can orchestrate the two-to-one communication path.

The host controller interface 210 includes the command controller 212 positioned between the key table 214 and the configuration interface 230. The command controller 212 is connected to key table 214, the CSR 216, and the configuration interface 230 via communication lines 202. The command controller 212 understands the AXI protocol and updates the key table 214 based on the communications and/or commands received from the flash storage driver 250 via the second bus 206. The command controller 212 also updates the CSR 216 based on the communications and/or commands received from the flash storage driver 250 also via the second bus 206. The command controller 212 also updates the key table 214 with the child keys communicated to the host controller interface 210, via the first bus 204, from the hardware key manager 110. The child keys are stored in key slots in the key table 214.

In some implementations, the flash storage wrapper 120 includes a controller 240 connected to the first bus 204 and the second bus 206 of the flash storage wrapper 120. The controller 240 is positioned between the hardware key manager 110 and the arbiter 220. The controller 240 performs access control and key policy checks for communications and/or commands received on the first and second buses 204, 206 of the flash storage wrapper 120. The controller 240 is configured to allow a hardware-generated key, the child key generated by the hardware key manager 110, to be communicated to the key table 214 of the host controller interface 210. The controller 240 is also configured to prevent a software-generated key from being communicated to the key table 214 of the host controller interface 210. The controller 240 prevents the flash storage driver 250 from submitting a software-generated encryption key to be entered into the key table 214. Although shown and described separately for clarity, the arbiter 220 or the controller 240 can be partially or fully combined.

The first cryptographic engine 218 of the host controller interface 210 cryptographically processes (e.g., encrypts or decrypts) files, or data, using the hardware-generated keys (e.g., child keys) stored in the key table 214 on the host controller interface 210. The first cryptographic engine 218 encrypts or decrypts a file based on I/O commands/information from the flash storage driver 250 sent via the second bus 206 into the flash storage wrapper 120.

If the I/O command/information is a write command, the I/O command/information from the flash storage driver 250 indicates where the file, or data, to be encrypted is located on a memory 108 of the SoC 104 of the mobile device 102. The I/O command/information also specifies which child key, stored in the key table 214 on the host controller interface 210, should be used to encrypt the file, or data. The I/O command/information also includes where the file, or data, once encrypted, should be written in the flash storage device.

If the I/O command/information is a read command, the I/O command/information from the flash storage driver 250 indicates the location on the flash storage device of the file, or data, that is to be read from the flash storage device. The I/O command/information also specifies which child key, stored in the key table 214 on the host controller interface 210, should be used to decrypt the file, or data. The I/O command/information also includes where the file, or data, once decrypted, should be written into the memory 108 of the SoC 104 of the mobile device 102.

The hardware key manager 110 is located on the SoC 104 of the mobile device 102. The hardware key manager 110 is configured to generate child keys, which are hardware-generated keys, to be used by the first cryptographic engine 218, located in the host controller interface 210, to cryptographically process files, or data, on the mobile device 102. The hardware key manager 110 sends the hardware-generated child key to the host controller interface 210 via the first bus, or first communication line, 204. The sent child key passes through the controller 240 before reaching the host controller interface 210. The controller 240 is configured to permit the child key to pass to the host controller interface 210, where it will be stored in a specified key slot of the key table 214 located in the host controller interface 210. The specified key slot of the key table 214 is indicated in key information received at the hardware key manager 110 from the flash storage driver 250.

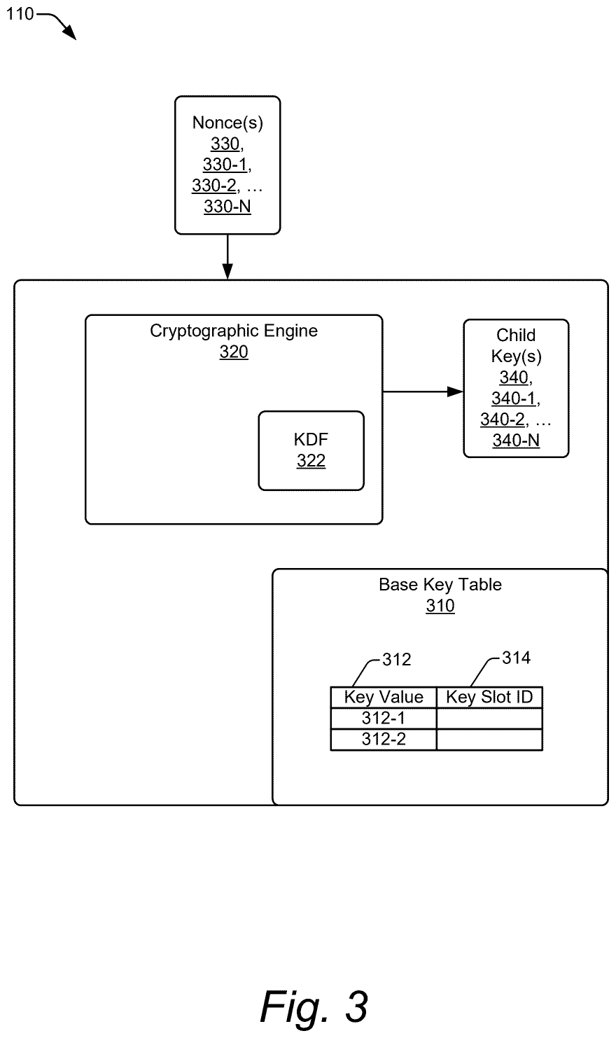

FIG. 3 illustrates an example configuration of a hardware key manager 110. In an implementation, the hardware key manager 110 is located on the SoC 104 of the mobile device 102. The hardware key manager 110 includes a second cryptographic engine 320 and the base key table 310. The second cryptographic engine 320 includes at least one key derivation function (KDF) 322 that may be used to derive base keys 312. Various KDFs 322 may be used by the second cryptographic engine 320 as would be appreciated by one of ordinary skill in the art having the benefit of this disclosure. For example, the KDF 322 could use, but is not limited to, the keyed-Hash Message Authentication Code, the Cipher-based Message Authentication Code, or the Keccak-based Message Authentication Code as pseudorandom functions as detailed in National Institute of Standards and Technology SP 800-108r1.

The base key table 310 includes one or more base keys 312 with corresponding base key slot IDs 314. In one implementation, the base key table 310 may only include a single base key 312 and a single corresponding base key slot ID 314. In another implementation, the base key table 310 may include between 1 and 4 base keys 312 with corresponding base key slot IDs 314. In yet another implementation, the base key table 310 may include 16 base keys 312 or 32 base keys 312 with corresponding base key slot IDs 314.

The hardware key manager 110 receives a nonce 330 from the flash storage driver 250, as discussed herein. The hardware key manager 110 applies the nonce 330 with the second cryptographic engine 320 to generate, or derive, a child key 340 from a base key 312. The nonce 330, or tweak, is applied to a specified base key 312, and the result is a child key 340. This is a repeatable process as the same nonce 330 applied to the same base key 312 will result in the generation of a child key 340 with the identical value as before. In one implementation, the hardware key manager 110 does not need to record the physical number of child keys 340 generated or the value of the generated child keys 340 because the process of generating child keys 340 is repeatable. Likewise, the hardware key manager 110 may not need to record the location in the key table 214 where child keys 340 are stored because the process of generating child keys 340 is repeatable.

The hardware key manager 110 is configured to generate an unlimited number of child keys 340 even if the base key table 310 includes a single base key 312. This is because the nonce 330 applied to the single base key 312 can be varied in an unlimited number of ways (e.g., 330-1, 330-2, 330-3, . . . 330-N) to generate an unlimited number of child keys 340.

In some implementations, the hardware key manager 110 may include multiple base keys 312-1, 312-2. In this instance, the hardware key manager 110 can generate a first child key 340-1 by the application of a first nonce 330-1 to a first base key 312-1. The hardware key manager 110 can generate a second child key 340-2, which differs from the first child key 340-1, by the application of the first nonce 330-1 to a second base key 312-2, which differs from the first base key 312-1. Likewise, the hardware key manager 110 can create a unique child kcy 340 by applying a second nonce 330-2, which differs from the first nonce 330-1, to either the first base key 312-1 or the second base key 312-2.

After generating the child key 340, the hardware key manager 110 communicates the generated child key 340 to the host controller interface 210 via the first bus 204 as discussed herein. The child key 340 is stored in the key table 214 in the host controller interface 210 to be used during the cryptographic process by the first cryptographic engine 218. Per-file encryption may specify that a different base key 312 is to be used to generate a child key 340 for each different type, or category, of file. For example, a first base key 312-1 may be used to generate the child key 340-1 for work files, and a second base key 312-2 may be used to generate the child key 340-2 for personal files. In one implementation, a first nonce 330-1 may be applied to a first base key 312-1 to create a first child key 340-1. A second nonce 330-2 may be applied to the first base key 312-1 to create a second child key 340-2. In other words, unique child keys 340 may be generated by using different base keys 312, using different nonces 330 applied to the base key 312, or each of the base key 312 and the nonce 330 may be varied to create unique child keys 340, 340-1, 340-2, . . . 340-N.

In one implementation, an ordinary, typical, or standard number of key slots in the key table 214, of the host controller interface 210, may be doubled to increase the efficiency of the encryption and decryption of data by the first cryptographic engine 218 of the host controller interface 210. For example, in one application, the key table 214, of the host controller interface 210, may normally have 16 key slots. In this implementation, the number of key slots in the key table 214 is doubled to 32 key slots to improve the efficiency of the cryptographic processing by the first cryptographic engine 218 of the host controller interface 210. By doubling the number of key slots of the key table 214, the host controller interface 210 may be able to use one set, or one group, of child keys 340 in the key slots of the key table 214 while cryptographically processing one set of files, or data. Simultaneously, the hardware key manager 110 may be able populate a second set, or second group, of key slots in the key table 214, of the host controller interface 210, with a second set of child keys 340. The second set of child keys 340 in the second set of key slots in the key table 214, on the host controller interface 210, may then be used by the first cryptographic engine 218, of the host controller interface 210, during the cryptographic processing for the next set of files, or data.

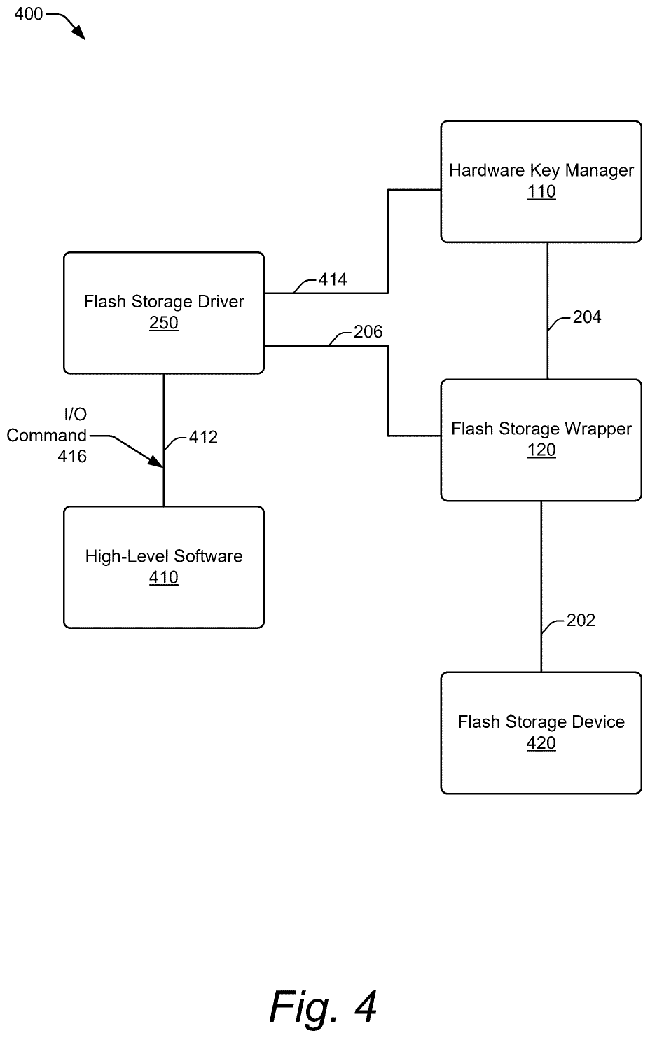

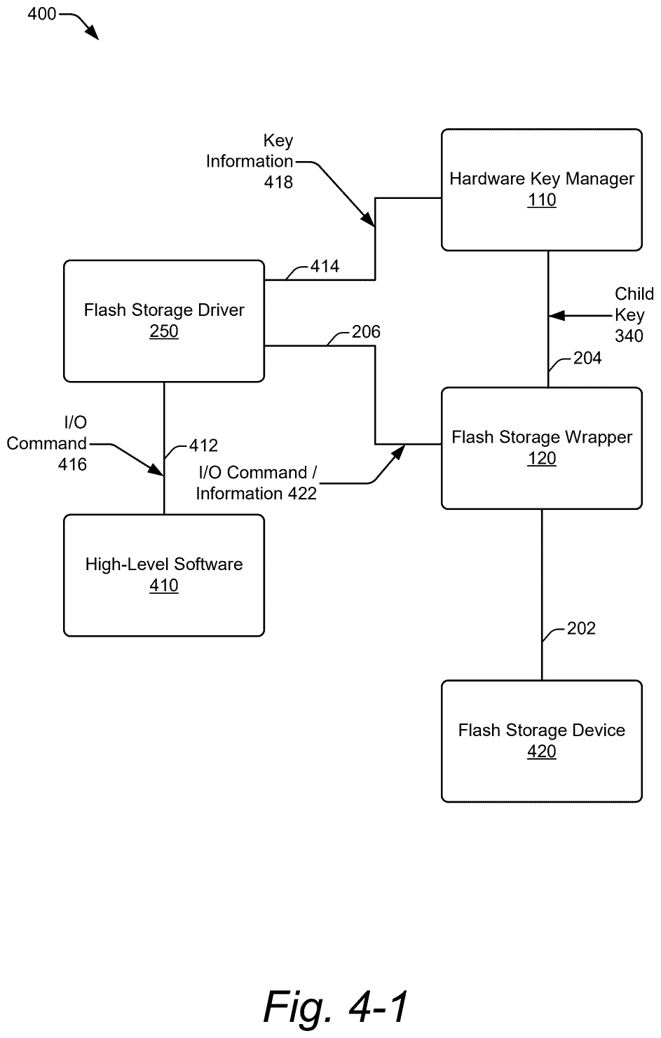

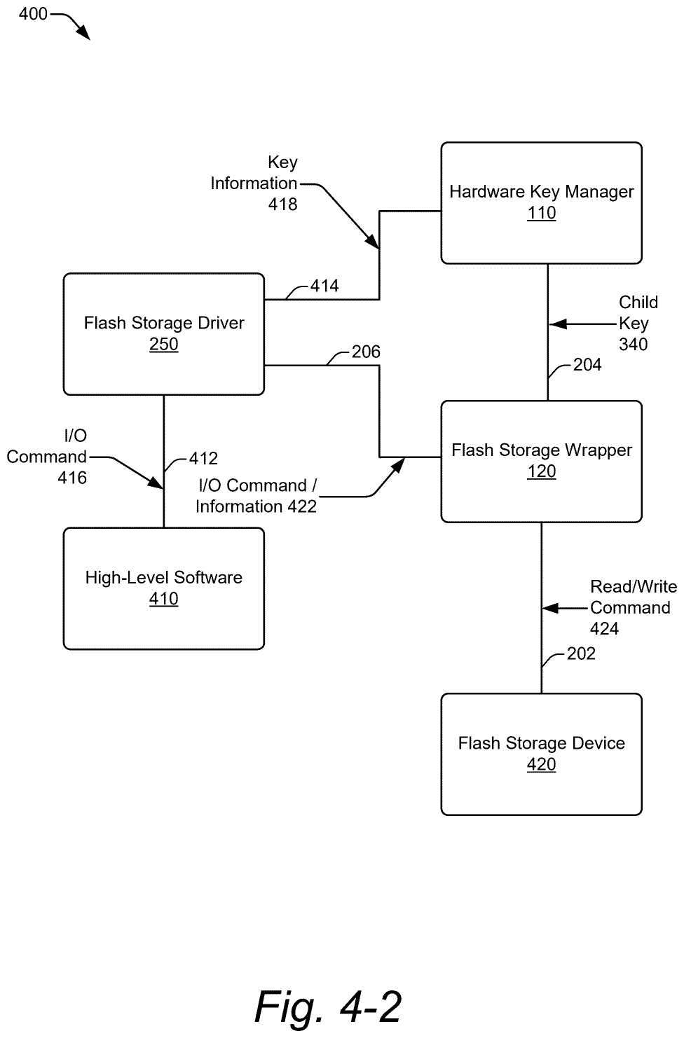

FIG. 4 illustrates an example system 400. The system 400 includes high-level software 410, such as an operating system. The high-level software 410 is connected to a flash storage driver 250 via a bus or communication line 412. The system 400 includes a hardware key manager 110 connected to a flash storage wrapper 120 via a first bus 204, also referred to herein as a first communication line. The flash storage driver 250 is connected to the flash storage wrapper 120 via a second bus 206, also referred to herein as a second communication line. The flash storage driver 250 is connected to the hardware key manager 110 via a third bus 414, also referred to herein as a third communication line. The flash storage wrapper 120 is connected to a flash storage device 420 via a bus or communication line 202.

As illustrated in FIG. 4, the high-level software 410 sends a memory command, or an I/O command 416, to the flash storage driver 250 via a communication line 412. The I/O command 416 may indicate a file, or data, that is to be encrypted using a first cryptographic engine 218 in a host controller interface 210 of the flash storage wrapper 120. Likewise, the I/O command 416 may indicate a file, or data, that is to be read from the flash storage device 420 and then decrypted using the first cryptographic engine 218 in the host controller interface 210 of the flash storage wrapper 120.

FIGS. 4-1 and 4-2 depict example operational scenarios using the hardware shown in FIG. 4. With reference now to FIG. 4-1, upon receipt of the I/O command 416, the flash storage driver 250 sends key information 418 to the hardware key manager 110 via the third bus 414. The key information 418 includes a nonce 330 as well as a designated, or specified, base key 312 to which the nonce 330 is to be applied by a second cryptographic engine 320 of the hardware key manager 110 to generate a child key 340. The key information 418 sent from the flash storage driver 250 optionally may also include a specified key slot in a key table 214 of the host controller interface 210 in the flash storage wrapper 120. The specified destination key slot is the location within the key table 214 where the child key 340, which is to be generated by the hardware key manager 110, will be stored. Upon receipt of the key information 418 via the third bus 414, the hardware key manager 110 generates a child key 340 with the second cryptographic engine 320 by applying the received nonce 330 to the specified base key 312.

Upon receipt of the I/O command 416, the flash storage driver 250 also sends I/O command/information 422 to the flash storage wrapper 120 via the second bus 206. If the I/O command 416 is a write command, the I/O command/information 422 can indicate to the host controller interface 210 the location in memory 108, of a mobile device 102, of the file, or data, that is to be encrypted. The I/O command/information 422 also indicates the location within the flash storage device 420 where the file, or data, is to be stored once it has been encrypted by the first cryptographic engine 218. Additionally, the I/O command/information 422 indicates which child key 340 the first cryptographic engine 218 should use to encrypt the specified file, or data, as well as the location of the child key 340 in the key table 214.

If the received I/O command 416 is a read command, the I/O command/information 422 indicates to the host controller interface 210 where to access the file, or data, that is to be read from the flash storage device 420. The I/O command/information 422 can also indicate the location within the memory 108 of the SoC 104 where the file, or data, should be written once the file, or data, has been decrypted by the first cryptographic engine 218. The I/O command/information 422 also indicates which child key 340 the first cryptographic engine 218 should use to decrypt the specified file, or data, as well as the location of the child key 340 in the key table 214.

After receiving the key information 418 from the flash storage driver 250, the hardware key manager 110 generates a hardware-generated key, the child key 340, based on the received nonce 330 being applied to the specified base key 312. The hardware key manager 110 then sends the child key 340 to the flash storage wrapper 120 via the first bus 204. As discussed herein, the child key 340 is stored in the key table 214 within the host controller interface 210 of the flash storage wrapper 120.

With reference now to FIG. 4-2, the first cryptographic engine 218 of the host controller interface 210 is then ready to perform the requested cryptographic processing after the host controller interface 210 of the flash storage wrapper 120 has received the child key 340 designated in the received I/O command/information 422. If performing a write operation to the flash storage device 420, the host controller interface 210 retrieves the specified file, or data, from the memory 108 on the SoC 104 and the first cryptographic engine 218 encrypts the file, or data, using the specified child key 340 stored in the key table 214. After the file, or data, is encrypted, the host controller interface 210 sends a write command 424 via a communication line 202 to the flash storage device 420 to store the encrypted file, or data, at the location specified in the received I/O command/information 422.

If performing a read operation from the flash storage device 420, the host controller interface 210 sends a read command 424 via a communication line 202 to retrieve the specified encrypted file, or data, from the flash storage device 420. The first cryptographic engine 218 then decrypts the file, or data, using the specified child key 340 stored in the key table 214. After the file, or data, has been decrypted, the host controller interface 210 sends the decrypted file, or data, to the flash storage driver 250 to store the file, or data, within the memory 108 of the SoC 104. In this system 400, the software of the mobile device does not need to access the values of the base keys 312 or the hardware-generated child keys 340.

### Example Methods

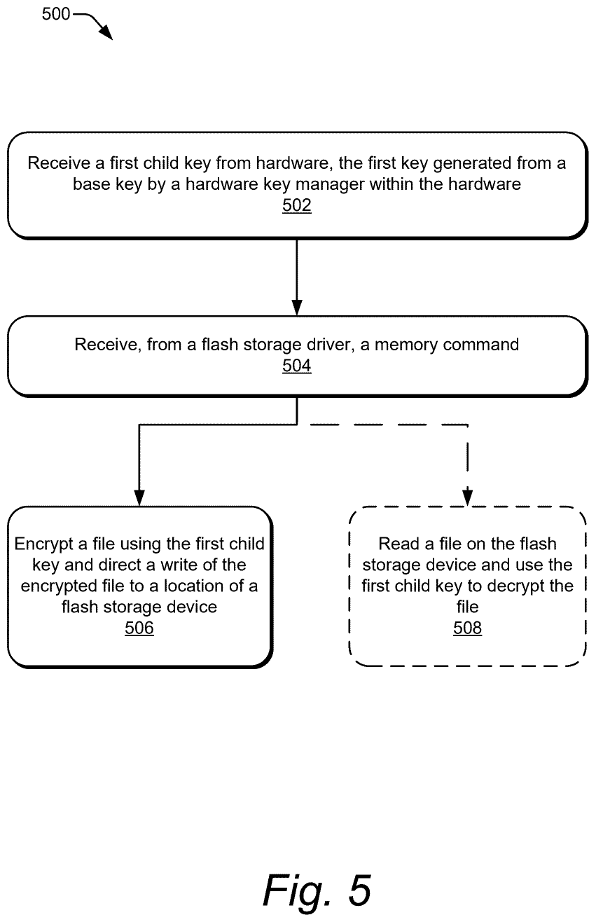

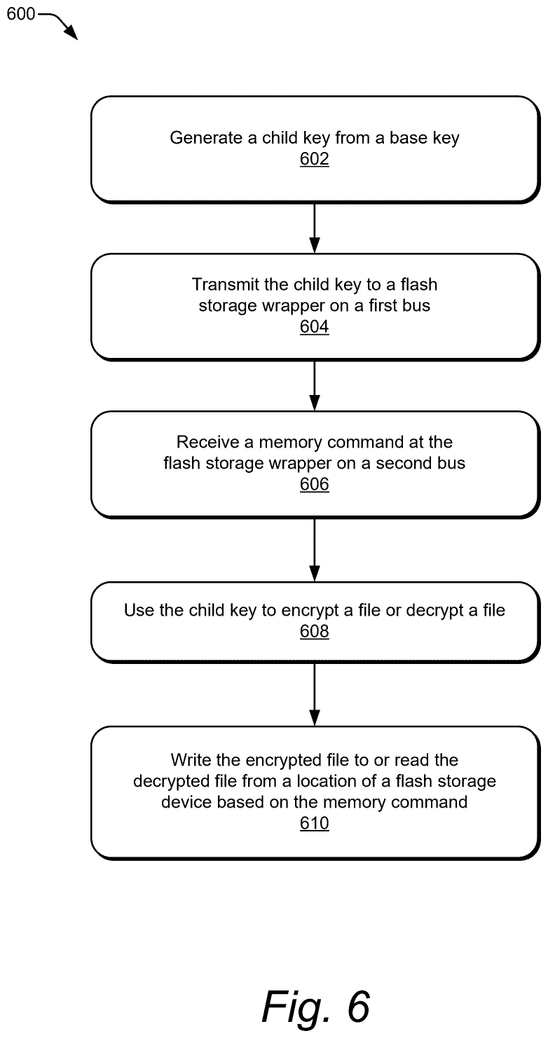

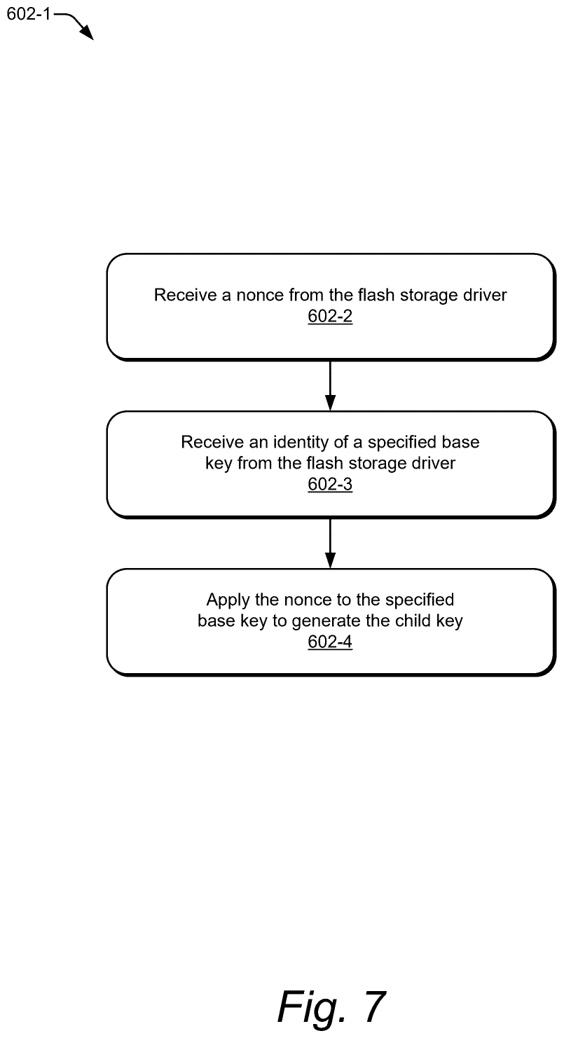

Example methods are described below with reference to the flow charts of FIG. 5, FIG. 6, and FIG. 7. Although example method aspects are described separately below, they may be implemented together in any combination or permutation.

FIG. 5 is a flow chart 500 illustrating an example method for implementing encryption or decryption using a hardware-generated key. The flow chart 500 includes four blocks 502-508. The operations of the example processes can be performed by electronic circuit components as described herein. For example, the operations may be performed by at least one instance of a flash storage wrapper 120 and a hardware key manager 110 located within the flash storage wrapper 120.

At 502, a flash storage wrapper 120 receives a first child key 340 generated from a base key 312 by a hardware key manager 110 within the hardware. In one implementation, the first child key 340 is received at the flash storage wrapper 120 via a first bus 204. The hardware key manager 110 may generate the child key 340 by applying a nonce 330 to the base key 312. At 504, the flash storage wrapper 120 receives, from a flash storage driver 250, a memory command 422. In one implementation, the flash storage wrapper 120 receives the memory command 422 from the flash storage driver 250 via a second bus 206.

At 506, the flash storage wrapper 120 encrypts a file using the first child key 340 and directs a write of the encrypted file to a location of a flash storage device 420. In one implementation, the flash storage wrapper 120 encrypts the file in accordance with the memory command 422 and writes the encrypted file to the location of the flash storage device 420 based on the memory command 422 received from the flash storage driver 250.

At 508, the flash storage wrapper 120 alternatively reads a file on the flash storage device 420 and uses the first child key 340 to decrypt the file. In one implementation the file is read at a location on the flash storage device 420 based on the memory command 422 received, via the second bus 206, by the flash storage wrapper 120 from the flash storage driver 250. The file is decrypted by the flash storage wrapper 120 in accordance with the received memory command 422.

FIG. 6 is a flow chart 600 illustrating an example method for implementing encryption using a hardware-generated key. The flow chart 600 includes five blocks 602-610. The operations of the example processes can be performed by electronic circuit components as described herein. For example, the operations may be performed by at least one instance of a hardware key manager 110 and a flash storage wrapper 120.

At 602, a hardware key manager 110 can generate a child key 340 from a base key 312. An example process for the operation 602 is described below with reference to FIG. 6. At 604, the hardware key manager 110 can transmit the child key 340 to a flash storage wrapper 120 on a first bus 204. In one implementation, the hardware key manager 110 may receive, from a flash storage driver 250, a specified key slot of a key table 214 in a host controller interface 210 in the flash storage wrapper 120. The child key 340 may be transmitted to the specified key slot of the key table 214. At 606, the flash storage wrapper 120 can receive a memory command 422 on a second bus 206. The I/O command/information 422 may indicate where the file, or data, to be encrypted is located on a memory 108 and which child key 340 should be used to encrypt the file, or data. Alternatively, the I/O command/information 422 may indicate the location on the flash storage device 420 of the file, or data, that is to be read and which child key 340 should be used to decrypt the file, or data.

At 608, a first cryptographic engine 218 of the host controller interface 210 in the flash storage wrapper 120 may use the child key 340 to encrypt a file, or data, or decrypt a file, or data. The host controller interface 210 may be realized with an off-the-shelf third-party flash storage controller as discussed herein. At 610, the host controller interface 210, based on the memory command 422, may write the encrypted file to or read the decrypted file from a location of a flash storage device 420. The I/O command/information 422 may include where the file, or data, once encrypted, should be written in the flash storage device 420 or where the file, or data, once decrypted, should be written into the memory 108 of the SoC 104 of the mobile device 102.

FIG. 7 is a flow chart 602-1 illustrating an example process for generating a child key 340 from a base key 312. At 602-2, a hardware key manager 110 receives a nonce 330 from a flash storage driver 250. The nonce 330 includes instructions on how to vary a base key 312 to form a child key 340. In other words, the child key 340 is the product that results when the nonce 330 is applied to the base key 312. At 602-3, the hardware key manager 110 receives an identity of a specified base key 312 from the flash storage driver 250. The specified base key 312 can be a designated base key 312 in a base key table 310 in the hardware key manager 110. At 602-4, the hardware key manager 110 applies the nonce 330 to the specified base key 312 to generate the child key 340.

One implementation of the method may include preventing a transmission of a software-generated key from the flash storage driver 250 to a host controller interface 210 of the flash storage wrapper 120. Another implementation includes the validation that the child key 340 was generated by the hardware key manager 110 prior to receipt of the child key 340 by the host controller interface 210 within the flash storage wrapper 120. Yet another implementation includes arbitrating communication between the host controller interface 210 and first and second buses, or communication lines 204, 206. The arbitration of communication may ensure that the first and second buses 204, 206 do not attempt to communicate with the host controller interface 210 simultaneously.

For the methods described herein and the associated flow chart(s) and flow diagram(s), the orders in which operations are shown and/or described are not intended to be construed as a limitation. Instead, any number or combination of the described method operations can be combined in any order to implement a given method or an alternative method, including by combining operations from the flow chart or diagram and the earlier-described schemes and techniques into one or more methods. Operations may also be omitted from or added to the described methods. Further, described operations can be implemented in fully or partially overlapping manners.

### Example Aspects and Implementations of Hardware-Generated Key Encryption

In the following, some example aspects and implementations are described:

Example aspect 1. An apparatus comprising: a first bus configured to receive communications from hardware; a second bus configured to receive communications from software; an arbiter connected to the first bus and the second bus, the arbiter having an output line; a host controller interface having a communication line connected to the output line of the arbiter, the host controller interface comprising a first cryptographic engine and a key table, the key table including a hardware-generated key, the hardware-generated key received from hardware via the first bus; and the first cryptographic engine configured to use the hardware-generated key to encrypt or decrypt a file received from software via the second bus.

Example aspect 2. The apparatus of example 1, further comprising: a hardware key manager connected to the host controller interface via the first bus, the hardware key manager is configured to generate the hardware-generated key.

Example aspect 3. The apparatus of example aspect 1 or example aspect 2, further comprising a controller connected to the first bus and the second bus.

Example aspect 4. The apparatus of any one of example aspects 1 to 3, wherein the controller is configured to: allow the hardware-generated key to be communicated to the host controller interface; and prevent a software-generated key from being communicated to the host controller interface.

Example aspect 5. The apparatus of any one of example aspects 1 to 4, wherein: the controller is connected between the first and second buses and the communication line of the host controller interface; and the controller is connected between the first and second buses and the arbiter.

Example aspect 6. The apparatus of any one of example aspects 1 to 5, further comprising a configuration interface connected between the output line of the arbiter and the communication line of the host controller interface, the arbiter configured to arbitrate communication with the configuration interface between the first bus and the second bus.

Example aspect 7. The apparatus of any one of example aspects 1 to 6, wherein the hardware key manager comprises a second cryptographic engine and a base key table.

Example aspect 8. The apparatus of any one of example aspects 1 to 7, wherein the key table of the host controller interface includes thirty-two key slots.

Example aspect 9. The apparatus of any one of example aspects 1 to 8, wherein the key table of the host controller interface includes sixty-four key slots.

Example aspect 10. The apparatus of any one of example aspects 1 to 9, wherein the base key table includes up to four base keys.

Example aspect 11. The apparatus of any one of example aspects 1 to 10, wherein the base key table includes at least sixteen base keys.

Example aspect 12. The apparatus of any one of example aspects 1 to 11, further comprising: at least one processor configured to execute a software driver in communication with the second bus; the software driver also in communication with the hardware key manager; and wherein the software driver is configured to communicate memory commands to the host controller interface via the second bus and to communicate a nonce to the hardware key manager.

Example aspect 13. The apparatus of any one of example aspects 1 to 12, wherein: the hardware key manager is configured to apply the nonce to a base key in the base key table to generate a child key; and the child key is the hardware-generated key.

Example aspect 14. The apparatus of any one of example aspects 1 to 13, wherein the hardware key manager is configured to communicate the child key to the host controller interface via the first bus.

Example aspect 15. The apparatus of any one of example aspects 1 to 14, wherein the host controller interface is configured to at least one of: encrypt a file using the child key and to write the encrypted file to a location on a flash storage device; or read a file from the flash storage device and decrypt the file using the child key.

Example aspect 16. A method comprising: generating, in a hardware key manager, a child key from a base key; transmitting, from the hardware key manager, the child key to a flash storage wrapper on a first bus; receiving, from a flash storage driver, a memory command at the flash storage wrapper on a second bus; using, at the flash storage wrapper, the child key to encrypt a file or decrypt a file; and writing the encrypted file to or reading the decrypted file from a location on a flash storage device based on the memory command.

Example aspect 17. The method of example aspect 16, wherein generating a child key from a base key comprises: receiving a nonce from the flash storage driver; receiving an identity of a specified base key from the flash storage driver; and applying the nonce to the specified base key to generate the child key.

Example aspect 18. The method of example aspect 16 or example aspect 17, further comprising: receiving, at the hardware key manager from the flash storage driver, a key, and a key slot of a key table in the flash storage wrapper; and wherein transmitting, from the hardware key manager, the child key to the flash storage wrapper on the first bus comprises transmitting the child key to the specified key slot of the key table in the flash storage wrapper.

Example aspect 19. The method of any one of example aspects 16 to 18, further comprising preventing a transmission of a software-generated key from the flash storage driver to a host controller interface of the flash storage wrapper.

Example aspect 20. The method of any one of example aspects 16 to 19, further comprising validating that the child key was generated by the hardware key manager prior to a host controller, within the flash storage wrapper, receiving the child key.

Example aspect 21. The method of any one of example aspects 16 to 20, further comprising arbitrating, with an arbiter, communication between the host controller interface with the first bus and the second bus.

Example aspect 22. A system comprising: a flash storage device; a flash storage wrapper in communication with the flash storage device, the flash storage wrapper including a first key table comprising multiple keys and multiple key slots, each key of the multiple keys corresponding to a key slot of the multiple key slots; a hardware key manager, the hardware key manager in communication with the flash storage wrapper via a first bus; and a flash storage driver in communication with the flash storage wrapper via a second bus and with the hardware key manager via a third bus.

Example aspect 23. The system of example aspect 22, wherein the hardware key manager is external to the flash storage wrapper.

Example aspect 24. The system of example aspect 22 or example aspect 23, comprising a system-on-chip of a mobile device, wherein the hardware key manager is located on the system-on-chip of the mobile device.

Example aspect 25. The system of any one of example aspects 22 to 24, wherein the hardware key manager comprises a cryptographic engine and a second key table, and the second key table comprises a base key and a base key slot that corresponds to the base key.

Example aspect 26. The system of any one of example aspects 22 to 25, wherein responsive to receipt of a first I/O command from software, the flash storage driver communicates first key information to the hardware key manager via the third bus.

Example aspect 27. The system of any one of example aspects 22 to 26, wherein the first key information comprises the base key, a first nonce, a first key of the multiple keys, and a key slot that corresponds to the first key.

Example aspect 28. The system of any one of example aspects 22 to 27, wherein upon receipt of the first I/O command from software, the flash storage driver communicates first I/O information to the flash storage wrapper via the second bus.

Example aspect 29. The system of any one of example aspects 22 to 28, wherein the hardware key manager applies the first nonce to the base key to generate a first child key.

Example aspect 30. The system of any one of example aspects 22 to 29, wherein the hardware key manager communicates the first child key to the flash storage wrapper via the first bus and wherein the first child key is stored in the first key table.

Example aspect 31. The system of any one of example aspects 22 to 30, wherein the flash storage wrapper uses the first child key to encrypt a first file and write the first file to the flash storage device.

Example aspect 32. The system of any one of example aspects 22 to 31, wherein the flash storage wrapper uses the first child key to decrypt a first file and read the first file from the flash storage device.

Example aspect 33. The system of any one of example aspects 22 to 32, wherein upon receipt of a second I/O command from software, the flash storage driver communicates second key information to the hardware key manager via the third bus.

Example aspect 34. The system of any one of example aspects 22 to 33, wherein the second key information comprises the base key, a second nonce, a second key of the multiple keys, and a key slot that corresponds to the second key.

Example aspect 35. The system of any one of example aspects 22 to 34, wherein upon receipt of the second I/O command from software, the flash storage driver communicates second I/O information to the flash storage wrapper via the second bus.

Example aspect 36. The system of any one of example aspects 22 to 35, wherein the hardware key manager applies the second nonce to the base key to generate a second child key.

Example aspect 37. The system of any one of example aspects 22 to 36, wherein the hardware key manager communicates the second child key to the flash storage wrapper via the first bus and wherein the second child key is stored in the first key table.

Example aspect 38. The system of any one of example aspects 22 to 37, wherein the flash storage wrapper uses the second child key to encrypt a second file and write the second file to the flash storage device.

Example aspect 39. The system of any one of example aspects 22 to 38, wherein the flash storage wrapper uses the second child key to decrypt a second file and read the second file from the flash storage device.

Example aspect 40. A method comprising: receiving, at a flash storage wrapper, via a first bus, and from hardware, a first child key, the first child key generated from a base key by a hardware key manager within the hardware; receiving at the flash storage wrapper, via a second bus, and from a flash storage driver, a memory command; and encrypting, at the flash storage wrapper, a file using the first child key and in accordance with the memory command and directing a write of the encrypted file to a location of a flash storage device, the location based on the memory command received from the flash storage driver; or reading, at the flash storage wrapper, a file on the flash storage device, the location of the file based on the memory command received from the flash storage driver and decrypting, at the flash storage wrapper, the file using the first child key and in accordance with the memory command.

Example aspect 41. The method of example aspect 40, wherein the first bus and the second bus are different.

Example aspect 42. The method of example aspect 40 or example aspect 41, wherein receiving the first child key and receiving the memory command are received from an arbiter, the arbiter connected to the first bus and the second bus and configured to arbitrate communications between the first and second buses and a host controller interface of the flash storage wrapper.

Example aspect 43. The method of any one of example aspects 40 to 42, wherein receiving the first child key and receiving the memory command are received from a controller, the controller connected to the first bus and the second bus, the controller configured to enable reception, by the host controller interface of the flash storage wrapper, the first child key and prevent reception, by the host controller interface of the flash storage wrapper, of a software-generated key.

Example aspect 44. The method of any one of example aspects 40 to 43, wherein the received memory command identifies a location within a key table within a host controller interface of the flash storage wrapper, and further comprising storing the received first child key at the location within the key table identified in the received memory command.

Example aspect 45. The method of any one of example aspects 40 to 44, wherein encrypting the file using the first child key encrypts using a first cryptographic engine within the host controller interface of the flash storage wrapper, the first cryptographic engine using the first child key stored in the key table.

Example aspect 46. The method of any one of example aspects 40 to 45, wherein directing the write of the encrypted file to the flash storage device is directed by the host controller interface of the flash storage wrapper.

Example aspect 47. The method of any one of example aspects 40 to 46, wherein reading the file on the flash storage device is read by the host controller interface of the flash storage wrapper.

Example aspect 48. The method of any one of example aspects 40 to 47, wherein decrypting the file using the first child key decrypts using a first cryptographic engine within the host controller interface of the flash storage wrapper, the first cryptographic engine using the first child key stored in the key table.

Example aspect 49. The method of any one of example aspects 40 to 48, wherein the received first child key is generated by: receiving, at the hardware key manager, via a third bus, a first nonce from the flash storage driver; receiving, at the hardware key manager, via the third bus, an identity of the base key in a base key table within the hardware key manager, the identity being received from the flash storage driver; and applying, by the hardware key manager, the first nonce to the identified base key to generate the first child key.

Example aspect 50. The method of any one of example aspects 40 to 49, wherein applying the first nonce to the base key applies using a second cryptographic engine within the hardware key manager.

Example aspect 51. The method of any one of example aspects 40 to 50, wherein the first bus, the second bus, and the third bus are different.

Example aspect 52. The method of any one of example aspects 40 to 51, further comprising generating a second child key, the second child key generated by: receiving, at the hardware key manager, via the third bus, a second nonce from the flash storage driver; receiving, at the hardware key manager, via the third bus, the identity of the base key in a base key table within the hardware key manager, the identity being received from the flash storage driver; and applying, by the hardware key manager, the second nonce to the identified base key to generate the second child key.

Example aspect 53. The method of any one of example aspects 40 to 52, wherein the flash storage wrapper comprises the controller, the arbiter, and the host controller interface.

Example aspect 54. The method of any one of example aspects 40 to 53, wherein the flash storage wrapper further comprises a configuration interface connected between the arbiter and the host controller interface.

Example aspect 55. A non-transitory computer readable memory storing instructions which, when executed by one or more processors, cause the one or more processors to executed any one of the methods of the example aspects 40 to 54.

Example aspect 56. An apparatus configured to perform a method of any one of example aspects 40 to 54. The apparatus may be the apparatus of example aspects 1 to 15.

Unless context dictates otherwise, use herein of the word “or” may be considered use of an “inclusive or,” or a term that permits inclusion or application of one or more items that are linked by the word “or” (e.g., a phrase “A or B” may be interpreted as permitting just “A,” as permitting just “B,” or as permitting both “A” and “B”). Also, as used herein, a phrase referring to “at least one of” a list of items refers to any combination of those items, including single members. For instance, “at least one of a, b, or c” can cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c, or any other ordering of a, b, and c). Further, items represented in the accompanying figures and terms discussed herein may be indicative of one or more items or terms, and thus reference may be made interchangeably to single or plural forms of the items and terms in this written description.

Although implementations for hardware-generated key encryption have been described in language specific to certain features and/or methods, the subject of the appended claims is not necessarily limited to the specific features or methods described. Rather, the specific features and methods are disclosed as example implementations for realizing hardware-generated key encryption.

1.-15. (canceled)

16. A method comprising:
receiving, at a flash storage wrapper, via a first bus and from a hardware key manager, a first child key, the first child key generated from a base key by the hardware key manager;
receiving, at the flash storage wrapper, via a second bus and from a flash storage driver, a memory command; and
encrypting, at the flash storage wrapper, a file using the first child key and in accordance with the memory command and directing a write of the encrypted file to a location of a flash storage device, the location based on the memory command received from the flash storage driver; or
reading, at the flash storage wrapper, a file on the flash storage device, a location of the file based on the memory command received from the flash storage driver and decrypting, at the flash storage wrapper, the file using the first child key and in accordance with the memory command.

17. The method of claim 16, wherein the first bus and the second bus are different.

18. The method of claim 16, wherein:
the receiving of the first child key and the receiving of the memory command comprise receiving the first child key from an arbiter and receiving the memory command from the arbiter, respectively, the arbiter connected to the first bus and the second bus; and
the method further comprises arbitrating, by the arbiter, communications between the first and second buses and a host controller interface of the flash storage wrapper.

19. The method of claim 18, wherein:
the receiving of the first child key and the receiving of the memory command comprise receiving the first child key from a controller and receiving the memory command from the controller, respectively, the controller connected to the first bus and the second bus; and
the method further comprises:
enabling, by the controller, reception of the first child key by the host controller interface of the flash storage wrapper; and
preventing, by the controller, reception of a software-generated key by the host controller interface of the flash storage wrapper.

20. The method of claim 16, wherein:
the memory command identifies a location within a key table within a host controller interface of the flash storage wrapper; and
the method further comprises storing the first child key at the location within the key table identified in the memory command.

21. The method of claim 20, wherein the encrypting of the file using the first child key comprises encrypting the file using a first cryptographic engine within the host controller interface of the flash storage wrapper, the first cryptographic engine using the first child key stored in the key table.

22. The method of claim 20, wherein the directing of the write of the encrypted file to the flash storage device comprises directing, by the host controller interface of the flash storage wrapper, the write of the encrypted file to the flash storage device.

23. The method of claim 20, wherein the reading of the file on the flash storage device comprises reading, by the host controller interface of the flash storage wrapper, the file on the flash storage device.

24. The method of claim 20, wherein the decrypting of the file using the first child key comprises decrypting the file using a first cryptographic engine within the host controller interface of the flash storage wrapper, the first cryptographic engine using the first child key stored in the key table.

25. The method of claim 16, further comprising generating the first child key by:
receiving, at the hardware key manager, via a third bus and from the flash storage driver, a first nonce;
receiving, at the hardware key manager, via the third bus and from the flash storage driver, an identity of the base key in a base key table within the hardware key manager; and
applying, by the hardware key manager, the first nonce to the base key to generate the first child key using the received identity.

26. The method of claim 25, wherein the applying of the first nonce to the base key comprises applying the first nonce to the base key using a second cryptographic engine within the hardware key manager.

27. The method of claim 25, wherein the first bus, the second bus, and the third bus are different.

28. The method of claim 25, further comprising generating a second child key by:
receiving, at the hardware key manager, via the third bus and from the flash storage driver, a second nonce;
receiving, at the hardware key manager, via the third bus and from the flash storage driver, the identity of the base key in the base key table within the hardware key manager; and
applying, by the hardware key manager, the second nonce to the base key to generate the second child key using the received identity.

29. An apparatus comprising:
a hardware key manager configured to generate a first child key from a base key; and
a flash storage wrapper connected to the hardware key manager and configured to:
receive, via a first bus and from the hardware key manager, the first child key;
receive, via a second bus and from a flash storage driver, a memory command; and
encrypt a file using the first child key and in accordance with the memory command and direct a write of the encrypted file to a location of a flash storage device, the location based on the memory command received from the flash storage driver; or
read a file on the flash storage device, a location of the file based on the memory command received from the flash storage driver, and decrypt the file using the first child key and in accordance with the memory command.

30. A system comprising:
a first bus configured to receive communications from a hardware key manager;
a second bus configured to receive communications from a flash storage driver; and
a flash storage wrapper including:
an arbiter connected to the first bus and the second bus, the arbiter having an output line; and
a host controller interface having a communication line connected to the output line of the arbiter, the host controller interface including a first cryptographic engine and a key table, the key table including a first child key generated by the hardware key manager,
the host controller interface configured to receive the first child key from the hardware key manager over the first bus and via the arbiter; and
the first cryptographic engine configured to use the first child key to encrypt or decrypt a file in accordance with a memory command received from the flash storage driver over the second bus and via the arbiter.

31. The system of claim 30, further comprising:
the hardware key manager connected to the host controller interface over the first bus and via the arbiter, the hardware key manager configured to generate the first child key.

32. The system of claim 31, wherein:
the flash storage wrapper includes a controller connected to the first bus and the second bus; and
the arbiter is connected between the controller and the host controller interface.

33. The system of claim 32, wherein the controller is configured to:
allow the first child key to be communicated to the host controller interface; and
prevent a software-generated key from being communicated to the host controller interface.

34. The system of claim 31, wherein:
the hardware key manager includes a second cryptographic engine and a base key table; and
the hardware key manager is configured to apply a nonce to a base key in the base key table to generate the first child key.

35. The system of claim 30, wherein:
the flash storage wrapper includes a configuration interface connected between the output line of the arbiter and the communication line of the host controller interface; and
the arbiter is configured to arbitrate communication with the configuration interface between the first bus and the second bus.
